(19) United States
(12) Patent Application Publication
(10) Pub. No.: US 2021/0132454 A1
(43) Pub. Date: May 6, 2021

(54) LCD PANEL AND LCD DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Sikun HAO, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/622,942

(22) PCT Filed: Nov. 8, 2019
(86) PCT No.: PCT/CN2019/116733

§ 371 Date: Dec. 16, 2019

(30) Foreign Application Priority Data
Oct. 30, 2019 (CN) 201911044982.3

(51) Int. Cl. G02F 1/1362

(52) U.S. Cl. CPC G02F 1/136286

(57) ABSTRACT

The disclosure provides an LCD panel and an LCD device. A common line is arranged in the LCD panel, and a projection of the common line on a substrate overlaps with a projection of a data line on the substrate, which prevents a pixel electrode from being affected by the data line. The common line reduces an area of a light-shading area, which enlarges a display area, increases an aperture ratio of the LCD panel, and alleviates a technical problem that an aperture ratio of conventional LCD panels is too low.

### FIELD

The present disclosure relates to the field of display technology and, more particularly, relates to an LCD panel and an LCD device.

### BACKGROUND

A shielding metal line is used in conventional liquid crystal display (LCD) panels to prevent a pixel electrode from being affected by a data line. To prevent light leakage from occurring between the data line and the pixel electrode, a black matrix is disposed at a region corresponding to an area between the data line and the pixel electrode. However, if the black matrix is too big, an aperture ratio of the LCD panel will be affected and become lower.

Consequently, there is a problem of lower aperture ratio among conventional LCD panels.

### SUMMARY

The present disclosure provides an LCD panel and an LCD device to solve a technical problem that an aperture ratio of conventional LCD panels is too low.

To solve the above problem, a technical solution provided by the present disclosure are described as follows:

The present disclosure provides an LCD panel, including: a substrate; a source/drain electrode layer disposed on a side of the substrate, wherein the source/drain electrode layer is patterned to form a data line; a pixel electrode layer disposed on a side of the source/drain electrode layer away from the substrate, wherein the pixel electrode layer is patterned to form a pixel electrode; and a common line layer, wherein the common line layer is patterned to form a common line, and a projection of the common layer on the substrate overlaps with a projection of the data line on the substrate.

The LCD panel includes at least two pixel units, each of the at least two pixel units includes a main pixel and a sub-pixel, and a common line is disposed on an area corresponding to the main pixel.

In the LCD panel provided by the present disclosure, the common line is also disposed on an area corresponding to the sub-pixel.

In the LCD panel provided by the present disclosure, the LCD panel further includes a first metal layer patterned to form a gate, the common line is disposed on the first metal layer, and the common line is insulated from the gate.

In the LCD panel provided by the present disclosure, the LCD panel includes a second metal layer, the second metal layer is disposed between the substrate and the source/drain electrode layer, the second metal layer is patterned to form a capacitor plate and a connecting line, and the connecting line is connected to the common line.

In the LCD panel provided by the present disclosure, the common line layer is disposed on a side of the source/drain electrode layer away from the substrate.

In the LCD panel provided by the present disclosure, the common line is disposed on the pixel electrode layer, and the common line is insulated from the pixel electrode.

In the LCD panel provided by the present disclosure, the LCD panel includes a first metal layer, the first metal layer is patterned to form a gate, the common line is disposed on the first metal layer, and the common line is insulated from the gate.

In the LCD panel provided by the present disclosure, the LCD panel includes a first metal layer, the common line includes a first common line and a second common line, the first common line is disposed on the first metal layer, and the second common line is disposed on the pixel electrode layer.

In the LCD panel provided by the present disclosure, the LCD panel further includes a second metal layer, the common line includes a first common line and a second common line, the first common line is disposed on the first metal layer, and the second common line is disposed on the pixel electrode layer.

The present disclosure provides an LCD device including an LCD panel and a backlight module, wherein the display panel includes: a substrate; a source/drain electrode layer disposed on a side of the substrate, wherein the source/drain electrode layer is patterned to form a data line; a pixel electrode layer disposed on a side of the source/drain electrode layer away from the substrate, wherein the pixel electrode layer is patterned to form a pixel electrode; and a common line layer, wherein the common line layer is patterned to form a common line, and a projection of the common layer on the substrate overlaps with a projection of the data line on the substrate.

In the LCD device provided by the present disclosure, the LCD panel includes at least two pixel units, each of the at least two pixel units includes a main pixel and a sub-pixel, and a common line is disposed on an area corresponding to the main pixel.

In the LCD device provided by the present disclosure, the common line is also disposed on an area corresponding to the sub-pixel.

In the LCD device provided by the present disclosure, the LCD panel further includes a first metal layer patterned to form a gate, the common line is disposed on the first metal layer, and the common line is insulated from the gate.

In the LCD device provided by the present disclosure, the LCD panel further includes a first metal layer patterned to form a gate, the common line is disposed on the first metal layer, and the common line is insulated from the gate.

In the LCD device provided by the present disclosure, the common line layer is disposed on a side of the source/drain electrode layer away from the substrate.

In the LCD device provided by the present disclosure, the common line is disposed on the pixel electrode layer, and the common line is insulated from the pixel electrode.

In the LCD device provided by the present disclosure, the LCD panel includes a first metal layer, the first metal layer is patterned to form a gate, the common line is disposed on the first metal layer, and the common line is insulated from the gate.

In the LCD device provided by the present disclosure, the LCD panel includes a first metal layer, the common line includes a first common line and a second common line, the first common line is disposed on the first metal layer, and the second common line is disposed on the pixel electrode layer.

In the LCD device provided by the present disclosure, the LCD panel further includes a second metal layer, the common line includes a first common line and a second common line, the first common line is disposed on the first metal layer, and the second common line is disposed on the pixel electrode layer.

Regarding the beneficial effects: the present disclosure provides an LCD panel and an LCD device. The LCD panel includes a substrate, a source/drain layer, a pixel electrode layer, and a common line layer. The source/drain layer is disposed on a side of the substrate and is patterned to form a data line. The pixel electrode layer is disposed on a side of the source/drain layer away from the substrate and is patterned to form a pixel electrode. The common line layer is patterned to form a common line. A projection of the common line on the substrate overlaps with a projection of the data line on the substrate. By disposing the common line in the LCD panel and making the projection of the common line on the substrate overlap with the projection of the data line on the substrate, the electrode pixel is prevented from being affected by the data line. The common line reduces an area of a light-shading area, which enlarges a display area, increases an aperture ratio of the LCD panel, and alleviates a technical problem that an aperture ratio of conventional LCD panels is too low.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a schematic view showing a conventional LCD panel.

FIG. 2 is a first schematic view showing an LCD panel provided by an embodiment of the present disclosure.

FIG. 3 is a second schematic view showing the LCD panel provided by the embodiment of the present disclosure.

FIG. 4 is a third schematic view showing the LCD panel provided by the embodiment of the present disclosure.

### DETAILED DESCRIPTION

The following description of the various embodiments is provided with reference to the accompanying drawings. It should be understood that terms such as “upper”, “lower”, “front”, “rear”, “left”, “right”, “inside”, “outside”, “lateral”, as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In the drawings, the identical or similar reference numerals constantly denote the identical or similar elements or elements having the identical or similar functions.

An embodiment of the present disclosure is used to solve a technical problem that an aperture ratio of conventional LCD panels is too low.

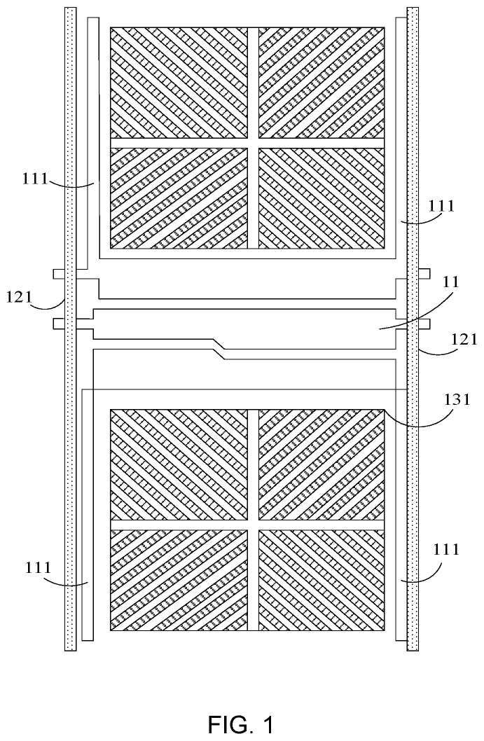

As shown in FIG. 1, in conventional LCD panels, pixel electrodes 131 are arranged in a fish-bone shape to form a plurality of viewing angle characteristics which are separated from each other. However, in processes of manufacturing an LCD panel, a plurality of data lines 121 will affect the pixel electrodes 131, resulting in generation of capacitors between the data lines 121 and the pixel electrodes 131, which affects display effect. Therefore, in conventional technology, a plurality of shielding metal lines 111 are disposed on a first metal layer 11, and projections of the shielding metal lines 111 on a substrate are located between projections of the pixel electrodes 131 and projections of the data lines 121 on the substrate. As a result, to block an area between the data lines 121 and the pixel electrodes 131, a black matrix is disposed on the area. However, the black matrix makes the area unable to display, reducing an aperture ratio of the LCD panel, which is a technical problem existing in conventional LCD panels.

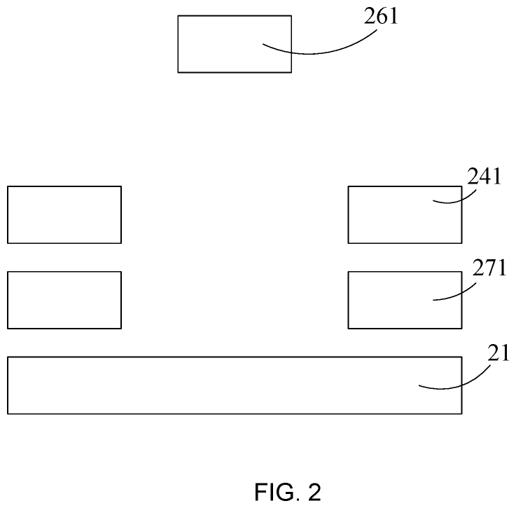

As shown in FIG. 2, the present disclosure provides an LCD panel, the LCD panel includes: a substrate 21; a source/drain layer disposed on a side of the substrate 21, wherein the source/drain layer is patterned to form a data line 241; a pixel electrode layer disposed on a side of the source/drain electrode layer away from the substrate, wherein the pixel electrode layer is patterned to form a pixel electrode 261; and a common line layer, wherein the common line layer is patterned to form a common line 271, and a projection of the common layer 271 on the substrate 21 overlaps with a projection of the data line 241 on the substrate 21.

An embodiment of the present disclosure provides an LCD panel and an LCD device, the LCD panel includes a substrate, a source/drain layer, a pixel electrode layer, and a common line layer. The source/drain layer is disposed on a side of the substrate and is patterned to form a data line. The pixel electrode layer is disposed on a side of the source/drain layer away from the substrate and is patterned to form a pixel electrode. The common line layer is patterned to form a common line. A projection of the common line on the substrate overlaps with a projection of the data line on the substrate. By disposing the common line in the LCD panel and making the projection of the common line on the substrate overlap with the projection of the data line on the substrate, the electrode pixel is prevented from being affected by the data line. The common line reduces an area of a light-shading area, which enlarges a display area, increases an aperture ratio of the LCD panel, and alleviates a technical problem that an aperture ratio of conventional LCD panels is too low.

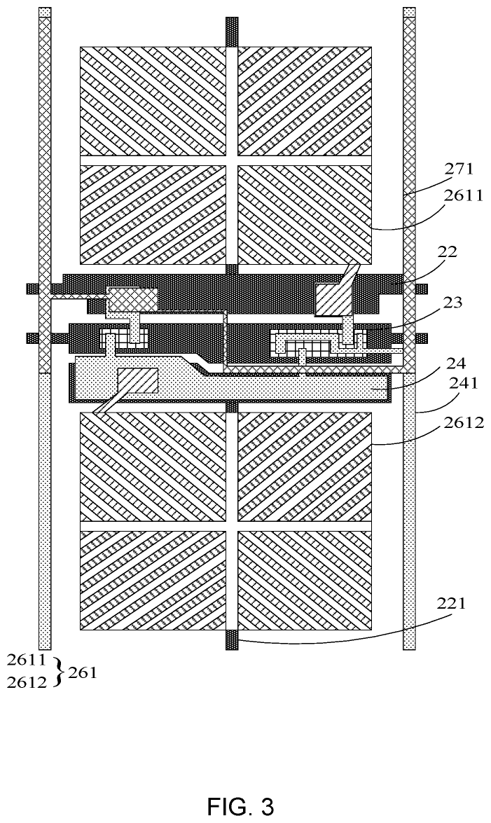

In one embodiment, as shown in FIG. 3, the LCD panel includes at least two pixel units. Each of the pixel units includes a main pixel and a sub-pixel. The common line 271 is disposed on an area corresponding to the main pixel. In FIG. 3, the main pixel includes a first pixel electrode 2611 and the sub-pixel includes a second pixel electrode 2612. In an LCD panel that divides its pixel into a main pixel and a sub-pixel, a pixel electrode may be prevented from being affected by a data line by disposing a common line on an area corresponding to the main pixel; furthermore, a projection of the common line on the substrate overlaps with a projection of the data line on the substrate so that the common line does not take up too much display space, or even does not occupy display space, which increases an area of the display area and increases an aperture ratio of a display panel. Besides, the distances between the pixel electrodes may be further reduced by not disposing the common line on an area corresponding to the sub-pixel, thereby further increasing the aperture ratio of the display panel. The sub-pixel has less effect on brightness of the display panel; therefore, the brightness of the display panel will not be significantly affected even though the common line is not disposed on the areas corresponding to the data line and the pixel electrode.

In one embodiment, the common line is further disposed on the area corresponding to the sub-pixel. To prevent the brightness of the display panel from being affected because a shielding metal line is removed, the common line may be disposed on both the areas corresponding to the main pixel and the sub-pixel so that shielding effect for the main pixel and the sub-pixel may be improved at the same time. Therefore, the pixel electrode may be prevented from being affected by the data line by the common line. Furthermore, the projection of the common line on the substrate overlaps with the projection of the data line on the substrate, thereby increasing the aperture ratio of the display panel without affecting the display brightness of the display panel.

In one embodiment, as shown in FIG. 3, the LCD panel further includes a first metal layer 22 disposed between the substrate 21 and the source/drain layer 24. The first metal layer 23 is patterned to form a gate and a connecting line 221 which is connected to the common line 271. When the common line is arranged, the common line may be disposed on the first metal layer which is an area between the LCD panel and pixels, and the above disposing method will not affect the aperture ratio of the LCD panel. Furthermore, the connecting line is connected to the common line so that the common line provides shielding effect on the data line and the pixel electrode. By cooperation of a plurality of common lines, the pixel electrode is further prevented from being affected by the data line.

In one embodiment, the LCD panel further includes a second metal line disposed between the substrate and the source/drain layer. The second metal layer is patterned to form a capacitor plate and a connecting line which are connected to each other. When the connecting line is arranged, the connecting line may be disposed on the second metal layer because the second metal layer has a bigger area, and the common line and the connecting line may be directly connected to each other or may be connected to each other by a through hole. Therefore, the connecting line may be correspondingly connected to the common line in each pixel so that the common line provides shielding effect on the data line and the pixel electrode in the LCD panel. By cooperation of a plurality of common lines, the pixel electrode is further prevented from being affected by the data line.

In one embodiment, the common line is disposed on a side of the source/drain layer away from the substrate. A common line layer, which forms the common line, may be added into the LCD panel to prevent the pixel electrode from being affected by the data line, and the common line layer will not affect disposing ways of the first metal layer, the second metal layer, the source/drain layer, and the pixel electrode layer.

In one embodiment, the common line is disposed on the pixel electrode layer. The common line and the pixel electrode layer are insulated from each other so that the common line will not affect voltage on the pixel electrode and will not affect other signals. Furthermore, a thickness of the display panel will not be increased because the common line is disposed on the pixel electrode layer, and the pixel electrode is prevented from being affected by the data line by the common line.

In one embodiment, the LCD panel further includes a first metal layer. The first metal line layer is patterned to form a gate. The common line is disposed on the first metal layer and is insulated from the gate. The pixel electrode will not be affected by the data line by the common line because the common line is disposed on the first metal layer. Furthermore, signals on the gate will not be affected by the common line when the LCD panel is driven because the common line is insulated from the gate. As a result, the LCD panel can display normally.

In one embodiment, the LCD panel includes the first metal layer, the common line further includes a first common line and a second common line, the first common line is disposed on the first metal layer, and the second common line is disposed on the pixel electrode layer. In a single pixel, the common line may be divided into the first common line and the second common line, wherein the first common line and the second line are not limited to be disposed on a same layer when the common line is patterned. The first common line is disposed on the first metal layer to prevent the pixel electrode from being affected by the data line at one side; the second common line is disposed on the pixel electrode layer to prevent the pixel electrode from being affected by the data line at the other side. Therefore, the common line may prevent the pixel electrode from being affected by the data line. In different pixels in the LCD panel, the first common line and the second common line may be alternately arranged in a column or in a row. That is, the first common line and the second common line are respectively disposed beside two sides of a column of the pixels, the first common line is disposed on the first metal layer, and the second common line is disposed on the second metal layer.

Alternatively, the first common line and the second common line are respectively disposed beside two sides of a row of the pixels. As a result, the pixel electrode can be prevented from being affected by the data line by both of the first common line and the second common line, and the pixel electrode can be prevented from being affected by the data line by the common line.

In one embodiment, the LCD panel includes the first metal layer and the second metal layer. The common line further includes a first common line and a second common line, the first common line is disposed on the first metal line, and the second common line is disposed on the second metal line. Therefore, the pixel electrode can be prevented from being affected by the first common line and the second common line. Meanwhile, the first common line and the second common line are respectively disposed on different layers, thereby reducing space of the layers occupied by the common layer. As a result, a situation that the common layer affects the layers because too much space of the layers is occupied by the common layer is prevented (the common line may in contact with other lines in layers, resulting in signal failure). By disposing the first common line and the second common line on different layers, an operation is simplified, and the layers are prevented from being affected by the common line.

In one embodiment, the LCD panel includes the second metal layer. The common line includes the first common line and the second common line, the first common line is disposed on the second metal layer, and the second common line is disposed on the pixel electrode layer. When the common line is arranged, the first common line and the second common line may be respectively disposed on the second metal layer and the pixel electrode layer, while the location of the common line is not limited to the present disclosure as long as the LCD panel may be operated normally.

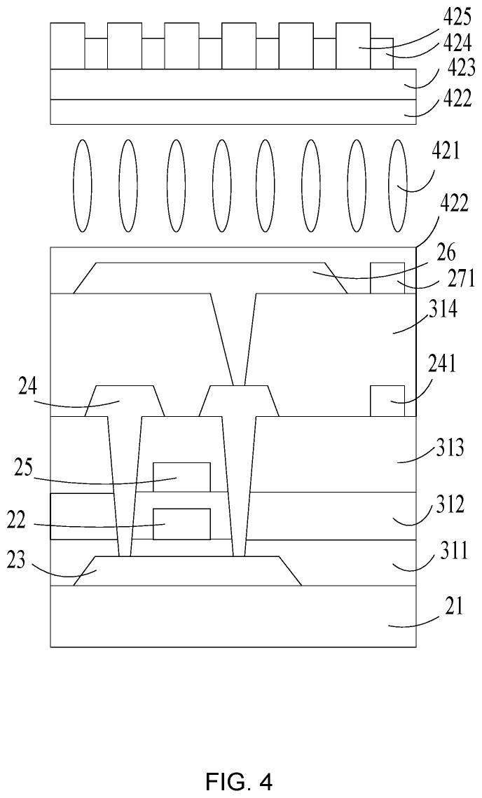

As shown in FIG. 4, an embodiment of the present disclosure further provides an LCD panel, including: a substrate 21; an active layer 23 disposed on the substrate 21; a first gate insulating layer 311 disposed on the active layer 23; a first metal layer 22 disposed on the first gate insulating layer 311; a second gate insulating layer 312 disposed on the first metal layer 22; a second metal layer 25 disposed on the second gate insulating layer 312; an interlayer insulating layer 313 disposed on the second metal layer 25; a source/drain layer 24 disposed on the interlayer insulating layer 313, wherein the source/drain layer 24 is patterned to from a data line 241; a planarization layer 314 disposed on the source/drain layer 24; a pixel electrode layer 26 disposed on the planarization layer 314; a common line 271, wherein a projection of the common line 271 on the substrate 21 overlaps with a projection of the data line 241 on the substrate 21; a liquid crystal layer, wherein the liquid crystal layer includes a liquid crystal 421 and an alignment layer 422 and is disposed on the pixel electrode 26; a common electrode layer 423 disposed on the liquid crystal layer; a black matrix layer 425 disposed on the common electrode layer 423; and a color resist layer 424 disposed in a light-emitting area defined by the black matrix layer 425.

An embodiment of the present disclosure provides an LCD device, including an LCD panel and a backlight module, wherein the LCD panel includes: a substrate; a source/drain electrode layer disposed on a side of the substrate, wherein the source/drain electrode layer is patterned to form a data line; a pixel electrode layer disposed on a side of the source/drain electrode layer away from the substrate, wherein the pixel electrode layer is patterned to form a pixel electrode; and a common line layer, wherein the common line layer is formed by a patterning process, and a projection of the common line on the substrate overlaps with a projection of the data line on the substrate.

The present embodiment provides an LCD device including an LCD panel and a backlight module. The LCD panel includes a substrate, a source/drain layer, a pixel electrode layer, and a common line layer. The source/drain layer is disposed on a side of the substrate and is patterned to form a data line. The pixel electrode layer is disposed on a side of the source/drain layer away from the substrate and is patterned to form a pixel electrode. The common line layer is patterned to form a common line. A projection of the common line on the substrate overlaps with a projection of the data line on the substrate. By disposing the common line in the LCD panel and making the projection of the common line on the substrate overlap with the projection of the data line on the substrate, the electrode pixel is prevented from being affected by the data line. The common line reduces an area of a light-shading area, which enlarges a display area, increases an aperture ratio of the LCD panel, and alleviates a technical problem that an aperture ratio of conventional LCD panels is too low.

In one embodiment, in the LCD device, the LCD panel includes at least two pixel units, each of the at least two pixel units includes a main pixel and a sub-pixel, and a common line is disposed on an area corresponding to the main pixel.

In one embodiment, in the LCD device, the common line is also disposed on an area corresponding to the sub-pixel.

In one embodiment, in the LCD device, the LCD panel further includes a first metal layer disposed between the substrate and the source/drain layer. The first metal layer is patterned to form a gate and a connecting line, and the connecting line is connected to the common line.

In one embodiment, in the LCD device, the LCD panel further includes a second metal layer disposed between the substrate and the source/drain layer. The second metal layer is patterned to form a capacitor plate and a connecting line, and the connecting line is connected to the common line.

In one embodiment, in the LCD device, the common line layer is disposed on a side of the source/drain electrode layer away from the substrate.

In one embodiment, in the LCD device, the common line is disposed on the pixel electrode layer, and the common line is insulated from the pixel electrode.

In one embodiment, in the LCD device, the LCD panel further includes a first metal layer, the first metal layer is patterned to form a gate, the common line is disposed on the first metal layer, and the common line is insulated from the gate.

In one embodiment, in the LCD device, the LCD panel further includes a first metal layer, the common line includes a first common line and a second common line, the first common line is disposed on the first metal layer, and the second common line is disposed on the pixel electrode layer.

In one embodiment, in the LCD device, the LCD panel further includes a second metal layer, the common line includes a first common line and a second common line, the first common line is disposed on the first metal layer, and the second common line is disposed on the pixel electrode layer.

According to the above embodiments, an embodiment of the present disclosure provides an LCD panel and an LCD device, the LCD panel includes a substrate, a source/drain layer, a pixel electrode layer, and a common line layer. The source/drain layer is disposed on a side of the substrate and is patterned to form a data line. The pixel electrode layer is disposed on a side of the source/drain layer away from the substrate and is patterned to form a pixel electrode. The common line layer is patterned to form a common line. A projection of the common line on the substrate overlaps with a projection of the data line on the substrate. By disposing the common line in the LCD panel and making the projection of the common line on the substrate overlap with the projection of the data line on the substrate, the electrode pixel is prevented from being affected by the data line. The common line reduces an area of a light-shading area, which enlarges a display area, increases an aperture ratio of the LCD panel, and alleviates a technical problem that an aperture ratio of conventional LCD panels is too low.

To sum up, the present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

1. A liquid crystal display (LCD) panel, comprising:
a substrate;
a source/drain electrode layer disposed on a side of the substrate, wherein the source/drain electrode layer is patterned to form a data line;
a pixel electrode layer disposed on a side of the source/drain electrode layer away from the substrate, wherein the pixel electrode layer is patterned to form a pixel electrode; and
a common line layer, wherein the common line layer is patterned to form a plurality of common lines, and a projection of the common layer on the substrate overlaps with a projection of the data line on the substrate;
wherein the LCD panel further comprises a first metal layer, the first metal layer is disposed between the substrate and the source/drain electrode layer, the first metal layer is patterned to form a gate and a connecting line, and the connecting line is connected to the common lines.

2. The LCD panel of claim 1, wherein the LCD panel comprises at least two pixel units, each of the at least two pixel units comprises a main pixel and a sub-pixel, and the common lines are disposed on an area corresponding to the main pixel.

3. The LCD panel of claim 2, wherein the common lines are also disposed on an area corresponding to the sub-pixel.

4. (canceled)

5. The LCD panel of claim 2, wherein the LCD panel further comprises a second metal layer, the second metal layer is disposed between the substrate and the source/drain electrode layer, the second metal layer is patterned to form a capacitor plate and the connecting line, and the connecting line is connected to the common lines.

6. The LCD panel of claim 1, wherein the common line layer is disposed on the side of the source/drain electrode layer away from the substrate.

7. The LCD panel of claim 1, wherein the common lines are disposed on the pixel electrode layer and are insulated from the pixel electrode.

8. The LCD panel of claim 1, wherein the common lines are disposed on the first metal layer and are insulated from the gate.

9. The LCD panel of claim 1, wherein the common lines comprise a first common line and a second common line, the first common line is disposed on the first metal layer, and the second common line is disposed on the pixel electrode layer.

10. The LCD panel of claim 1, wherein the LCD panel further comprises a second metal layer, the common lines comprise a first common line and a second common line, the first common line is disposed on the second metal layer, and the second common line is disposed on the pixel electrode layer.

11. A liquid crystal display (LCD) device, comprising an LCD panel and a backlight module, wherein the LCD panel comprises:
a substrate;
a source/drain electrode layer disposed on a side of the substrate, wherein the source/drain electrode layer is patterned to form a data line;
a pixel electrode layer disposed on a side of the source/drain electrode layer away from the substrate, wherein the pixel electrode layer is patterned to form a pixel electrode; and
a common line layer, wherein the common line layer is patterned to form a plurality of common lines, and a projection of the common layer on the substrate overlaps with a projection of the data line on the substrate;
wherein the LCD panel further comprises a first metal layer, the first metal layer is disposed between the substrate and the source/drain electrode layer, the first metal layer is patterned to form a gate and a connecting line, and the connecting line is connected to the common lines.

12. The LCD device of claim 11, wherein the LCD panel comprises at least two pixel units, each of the at least two pixel units comprises a main pixel and a sub-pixel, and the common lines are disposed on an area corresponding to the main pixel.

13. The LCD device of claim 12, wherein the common lines are also disposed on an area corresponding to the sub-pixel.

14. (canceled)

15. The LCD device of claim 12, wherein the LCD panel further comprises a second metal layer, the second metal layer is disposed between the substrate and the source/drain electrode layer, the second metal layer is patterned to form a capacitor plate and the connecting line, and the connecting line is connected to the common lines.

16. The LCD device of claim 11, wherein the common line layer is disposed on the side of the source/drain electrode layer away from the substrate.

17. The LCD device of claim 11, wherein the common lines are disposed on the pixel electrode layer and are insulated from the pixel electrode.

18. The LCD device of claim 11, wherein the common lines are disposed on the first metal layer and are insulated from the gate.

19. The LCD device of claim 11, wherein the common lines comprise a first common line and a second common line, the first common line is disposed on the first metal layer, and the second common line is disposed on the pixel electrode layer.

20. The LCD device of claim 11, wherein the LCD panel further comprises a second metal layer, the common lines comprise a first common line and a second common line, the first common line is disposed on the second metal layer, and the second common line is disposed on the pixel electrode layer.
